(19) United States
(12) Patent Application Publication
(10) Pub. No.: US 2016/0188643 A1
(43) Pub. Date: Jun. 30, 2016

(54) METHOD AND APPARATUS FOR SCALABLE SORTING OF A DATA SET

(71) Applicant: Futurewei Technologies, Inc., Plano, TX (US)

(72) Inventors: Yan SUN, Santa Clara, CA (US); Norbert EGI, Santa Clara, CA (US); Edward CHING, Hillsborough, CA (US)

(21) Appl. No.: 14/588,033

(22) Filed: Dec. 31, 2014

(51) Int. Cl. G06F 17/30

(52) U.S. Cl. CPC G06F 17/30327; G06F 17/30336

(57) ABSTRACT

Embodiments of the present invention pertain to a method and apparatus for a scalable sorting of a data set in a database on a computer system. A number of contiguous ranges spanning the data set are defined. Each individual data value of the data set is assigned to a range to which it falls into. The values in the ranges are then sorted. The sorting can be performed by different nodes in parallel. Once the sorting is completed, the results are stored in contiguous memory locations. This results the overall data set being sorted.

### FIELD OF THE INVENTION

Embodiments of the present invention generally relate to sorting data whereby the data is assigned to ranges, each range is sorted, which results in an overall sorted data set.

### BACKGROUND OF INVENTION

A database is an organized collection of data that is stored electronically on a computer based storage system. A database management system consisting of computer software is used to interact with the database. The database management system provides various functions that enable the entry, storage, processing, and retrieval of the information. One of the functions typically performed on a database is a sort operation. The data is oftentimes sorted according one or more criteria. For example, it may be useful for prospective homebuyers to sort a database of new home offered for sale according to price (e.g., lowest to highest); location (e.g., nearest to farthest from a specific desired location); age (e.g., newest to oldest); size (e.g., largest to smallest); etc.

In the past, simple sorting programs have been used to perform the sort operation. For example, MapReduce is a popular software program used to support scalable distributed processing on large data sets stored in a file system over a large set of computing nodes of a distributed processing system. Many enterprises rely on timely analysis of the MapReduce framework and its open-source implementation, Hadoop, as a platform choice for efficient processing and advanced analytics for large amounts of unstructured information.

Basically, MapReduce includes map and reduce functions. The map function divides the input data into smaller projects and distributes the projects to the worker nodes. The worker nodes process the projects and return the answer to the master node. As part of the reduce function, the master node collects the answers and combines them to provide an output.

More specifically, the map stage is partitioned into map tasks and the reduce stage is partitioned into reduce tasks. Each map task processes a logical split of input data that generally resides on a distributed file system. The map task reads the data, applies the user-defined map function on each record, and buffers the resulting output. In many instances, this data is sorted and partitioned for different reduce tasks, before being written to the local disk of the machine executing the map task.

The reduce stage consists of several phases: shuffle phase, sort phase, and reduce phase. Sorting operations usually take the longest time and becomes a bottleneck of data processing, especially for large data sets. This can be problematic, given the ever increasing amounts of data called upon to be sorted. Even with the latest technology, a large server farm utilizing MapReduce takes hours to sort a petabyte of data. Indeed, adding more nodes in an effort to increase processing power, yields diminishing returns because this results in an overabundance of data transfers between nodes, which, in turn, becomes a significant bottleneck.

Therefore, what is needed is a more efficient and faster way to sort, retrieve and update large sets of data stored in a database.

### SUMMARY

A method and apparatus for sorting data in a distributed database system, whereby the data is selectively sent to the appropriate nodes for sorting is disclosed. Initially, the data is divided into a range of values. These values can be numbers, or can be characters having a pre-determined order (e.g., alphabetical), or a combination thereof. The ranges are contiguous. The nodes of a distributed database system are assigned different ranges of values for purposes of sorting. Data is then distributed to the node having the range of values that the data falls into. Once the data set has been assigned to the various nodes, the individual nodes perform a sort on its data. The results from the sorting performed by the nodes are then written to pre-determined locations. And because the values within each range are sorted and the ranges are contiguous, the results from each of the nodes can be written to pre-determined memory locations such that the overall data set is sorted without having to do any other processing.

In one embodiment, the ranges are stored as sorting indexes, which can be used to facilitate subsequent sorting operations.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a figure of a database system upon which embodiments of the present invention may be practiced.

FIG. 2 is a flowchart of a process of sorting cache according to embodiments of the present invention.

FIG. 3 is a flowchart of sort and merges operations in parallel based on the sorting index according to embodiments of the present invention.

FIG. 4 is a diagram of the structure of a node in the sorting index tree according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter. Some portions of the detailed description are presented in terms of procedures, steps, logic blocks, processing, and other symbolic representations of operations on data bits that can be performed on computer memory.

These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities.

In one embodiment of the present invention, a sort operation is performed on a data set. The present invention can handle any size of data set. The data set is divided into a number of ranges corresponding to the number of nodes that is processing the data to be sorted. The ranges are contiguous, non-overlapping, and they cover the entire set of values stored in the data. These values can be numbers, or can be characters having a pre-determined order (e.g., alphabetical), or a combination thereof. The nodes of a distributed database system are assigned different ranges of values for purposes of sorting. In general, a value is selected that set the boundary between two ranges. Data is then distributed to the particular node having the range of values that the data happens to fall into. Once the data set has been assigned to the various nodes, the individual nodes perform a sort on its own data. The results from the sorting performed by the nodes are then written to pre-determined locations. This automatically results in the entire data set being sorted, without having to perform any additional processing steps. In one embodiment, the ranges are stored as sorting indexes, which can be used to facilitate subsequent sorting operations. They need not be calculated anew for each and every sort operation, thereby saving valuable processing power and time. These sorting indexes are updated when the data set is changed (e.g., data added or deleted).

An example is now described to aid in understanding one embodiment of the present invention. In this example, a small data set is given for purposes of clarity and simplicity of illustrating the invention. In practical applications, the data set is quite large and extensive. Suppose that the task is to sort the following data set of numbers from smallest to largest: 1, 3, 4, 2, 6, and 5. Initially, a value is chosen that separates two ranges. In this example, the value “3” is selected. Any values 3 or less falls into the first range, whereas any values greater than 3 falls into the second range. In other words, the first range is 1-3, and the second range is 4-6. Once the ranges are established, the sorting process assigns the individual data values into their appropriate ranges. In this example, the value 1 is assigned to the first range because it falls between 1-3. The next value, 3, is also assigned to the first range because it falls between 1-3. The third value is 4. It is assigned to the second range because it falls between 4-6. The fourth value, 2, is assigned to the first range. The last two values, 6 and 5, fall into the second range. Consequently, the first partition contains the values 1, 3, and 2. The second partition contains the values 4, 6, and 5. A sort operation is performed on each of these partitions. The sort operation can be performed on these smaller partitions in parallel (i.e., simultaneously by two different nodes). More specifically, one node sorts the values assigned to the first partition. Another node sorts the values assigned to the second partition. In this example, one node sorts the values 1, 3, and 2; another node sorts the values 4, 6, and 5. Upon completion of the sort operations, the first partition contains the values 1, 2, and 3, and the second partition contains the values 4, 5, and 6. These two partitions are then written directly to contiguous memory locations without having to perform any subsequent operations. In other words, the first partition is written to a memory location and the second partition is written to a subsequent, adjacent memory location. In the example the entire data set is sorted by writing the first partition (1, 2, and 3) to memory followed by writing the second partition (4, 5, and 6) to an adjacent memory location, which results in the entire sorted data set of (1, 2, 3, 4, 5, and 6).

In one embodiment, a data set is first divided into smaller data kernels or clusters and then sent to a node to perform sorting. Once all the smaller data kernels are processed and sent to the respective nodes, then the entire set of nodes or lists is merged together. In this instance, the merge sort takes advantage of the ease of merging already sorted lists into a new sorted list. To perform this sort/merge routine, a first to second daisy chain function of comparisons is performed for each of the nodes or lists. For example, the first and second list items are compared by comparing every two elements (i.e., 1 with 2, then 3 with 4 . . . ) and swapping each item if the first should come after the second. The processor is instructed to merge each of the resulting lists of two into lists of four. The processor then merges those lists of four, and repeats this process until the last two lists are merged into the final sorted list. This process scales well with large lists, because the worst-case running time is O(n log n). Furthermore, the process is flexible and can be applied to lists as well as arrays. This advantage is due to the feature that the process requires sequential access as opposed to random access.

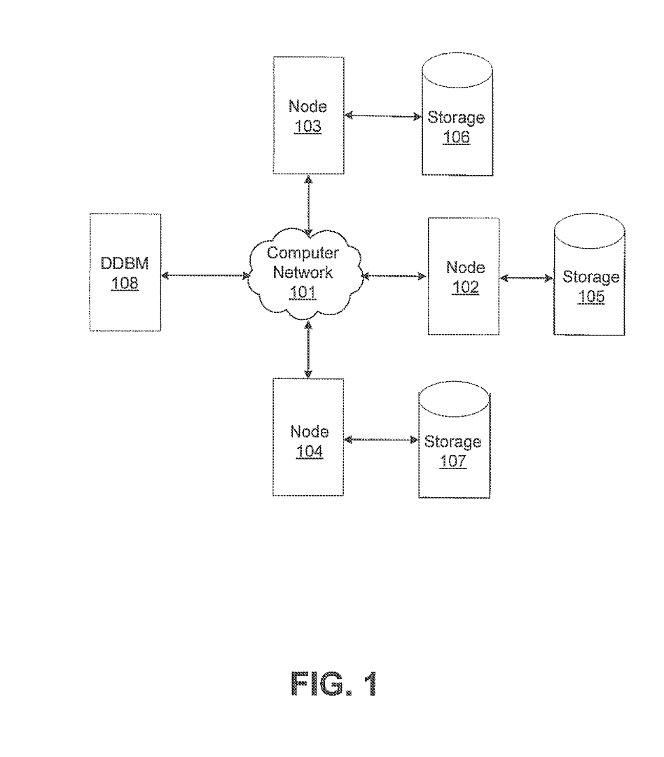

With reference to FIG. 1, a distributed database system upon which embodiments of the present invention may be implemented is shown. A computer network 101 is used to carry electronic communications between the various nodes 102-104. The computer network 101 can be a local area network, a wireless network, a part of the Internet, etc. Nodes 102-104 can be computer systems such as servers, workstations, mainframes, or be part of a cloud based computer system or some type of virtualized computer system. The nodes 102-104 are coupled to either dedicated, shared, or virtualized storages 105-107. A distributed database manager station 108 is used to access, control, and otherwise run and maintain the distributed database system. In one embodiment, the sorting process is executed on the DDBM 108. DDBM 108 assigns a range of values for each of the nodes 102-104. One aspect is to assign the ranges to distribute the workload equally amongst the nodes. Another aspect is to assign the ranges to achieve a balanced workload amongst the nodes. The data set is then distributed to the various nodes 102-104 according to these ranges. The nodes 102-104 perform a sorting routine on the parts of the data set that was distributed to it. The results from each of the nodes 102-104 are then written to predetermined memory locations. And since the ranges were intentionally designed to be sequential, the results from each of the nodes 102-104 will be sorted sequentially as well, without having to perform any additional processing.

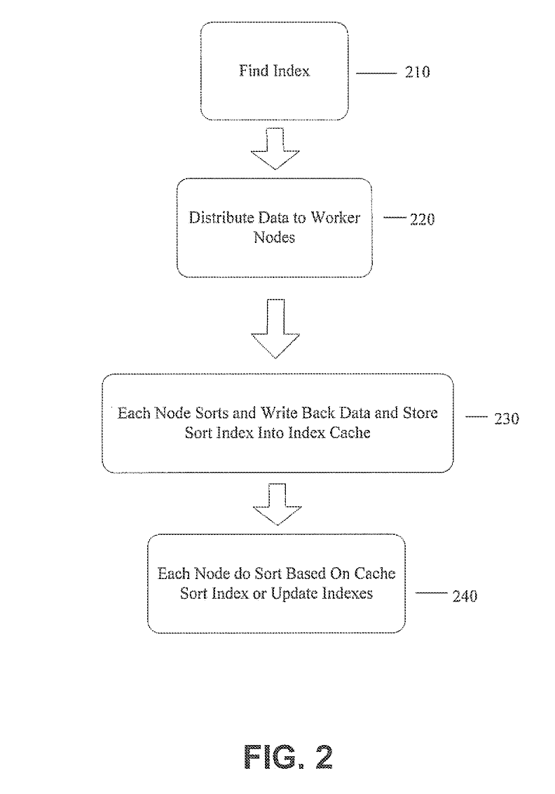

With reference to FIG. 2, a process flow according to one embodiment is shown. In this embodiment, the data set is divided based on the value needed to sort the data set. The sorted data is sent to each node data which is associated with the sorted data. At the initial stage 210, it is necessary to find the sorting index. Once the sorting index is determined, the data is distributed to worker nodes in stage 220. Each node sorts and writes back data and stores the sorted results into the index cache in stage 230. The sort is performed based on the cached stored index or update indexes in stage 240. Therefore, each node has a range for each value (e.g., a column in a database). When the sorting is done, the sorted data can be written into predicted locations in the file system. The ranges as referred to earlier, are the sorting indexes, and these indexes are cached in a tree data structure for further usage to save time. In other embodiments, the index can be stored in an array structure or a heap structure. Furthermore, they can be changed when the data set is changed (e.g., when data is added or deleted). By using the index, it becomes very efficient, fast, and economical to distribute the data to nodes. It should be noted that the stage 210 of finding the indexes can be done either by the master node only or by multiple nodes. The assumption is that there are n items that need to be sorted and m processing nodes.

Further, in one embodiment, if in the initial stage 210, there is no index cache information, it becomes necessary to find the (n/m)th, (2n/m)th, . . . , ((m−1) n/m)th value. This process can be performed by one node or multiple nodes, and the complexity is O(mn). Subsequently, the stage of storing these indexes in a binary search tree structure can be implemented. If duplicated values exist, these duplicates can be added to the tree node. There are two ways to add the duplicate values: the first way is to distribute the value based on the sort index and then these nodes can sort in parallel.

The second way is to divide the data based into separate parts, and each node processes one part. In addition, the nodes exchange values based on the sorting index. Thereby, the sorting and merging are processed in parallel.

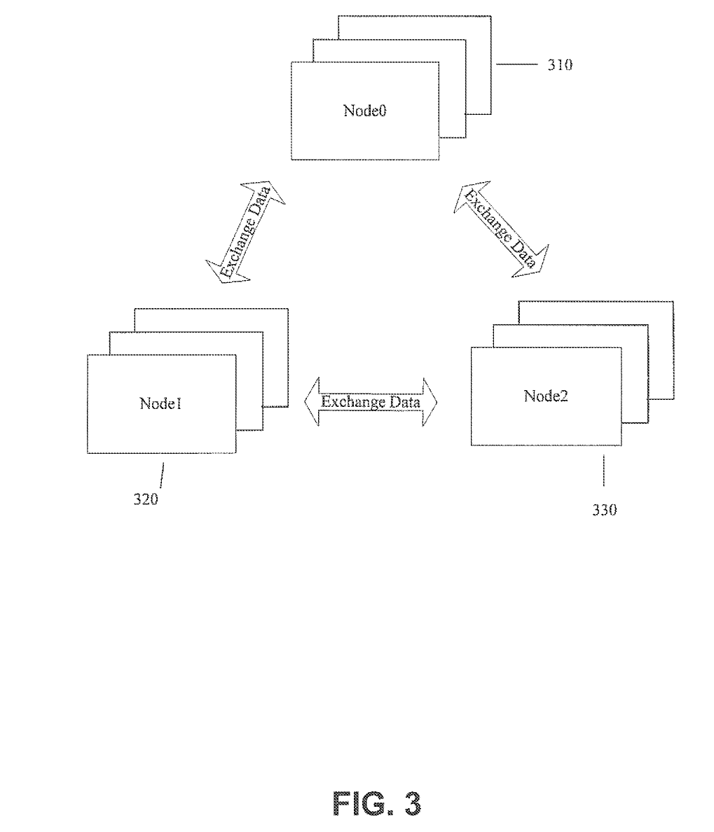

Referring now to FIG. 3, a sort and merge operation is shown. The sort and merge can be processed in parallel based on the sorting index. For example, node0 (310) exchanges data with node1 (320) and node1 exchanges data with node2 (330) such that each node knows the final node to which the data belongs. In one embodiment, the value is initially distributed based on the sort index. Thereupon, the nodes can sort in parallel. In another embodiment, the data is divided into pieces, and each node processes its piece of the data. The nodes subsequently exchange values based on the sorting index, such that the sorting and merging is processed in parallel. In both embodiments, each node is aware of the final node to which the data belongs.

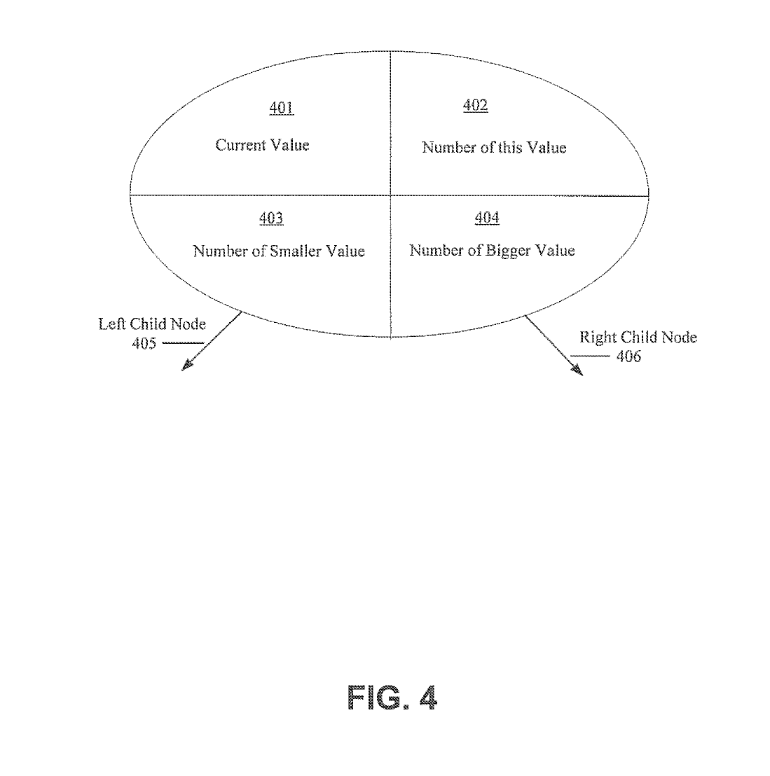

With reference to FIG. 4, the structure of a node in a sorting index tree is shown. Every node has the following information: the current value 401, the number of the current value 402, the number of data smaller than the current value 403, and the number of data larger than the current value 404. In addition, every node, with the exception of the bottom-most (leaf) nodes, has a left child node pointer 405 and a right child node pointer 406. A child node is a node that is further down from its dependent node in a node tree data structure. When updating data by either adding and/or deleting a value, the indexes are updated by finding the next larger or smaller value. The complexity for this operation is O(n). In order to reduce the frequency of such updates, a “window” can be used to delay the update of the index, and the update then occurs when the step of performing the sorting or the number of date set updates exceeds the window size.

An example is now described to illustrate the functionality of a node. In this example, the following data for a root node is given as:

Unsorted data: 1, 5, 2, 5, 7, 8, 4
Current value: 5
Number of this value: 2
Number of smaller value: 3 (1, 2 and 4)
Number of bigger value: 2 (7 and 8)
Therefore, the index for this particular node stores the following information: 5, 2, 3, and 2.

Overall, the proposed approach is based on the observation that coarse sorting before fine sorting becomes more and more important for big data and the coarse sorting information could be reused because it uses less memory and can be stored easily. This allows for both a reduction in data movement between nodes since the network bandwidth is still one of the dominant bottlenecks in cluster-based appliances and it also reduces data movement between slow storage such as disk and computing units.

The benefit of this approach is that it accelerates the sorting speed, especially for the repeated sorting. Moreover, the cache size is relatively very small, such that the storage cost is quite minimal. Because the sort operation is widely used, for example, in database operations, the sorted results could be used as the final results or intermediate results for other operations, such as joining two tables. Some other applications include, but are not limited to the following. Find/sort the top n items functions experience improved performance due to the elimination of several steps. By utilizing embodiments of the present invention, there is no need to process the whole data set. Applications with a hardware sort engine also experience improved performance because the present invention minimizes frequent data transfer. Fuzzy logic/computing are ideal for implementing the present invention due to the importance of ranges. Yet another application that the present invention improves performance pertains to “Join” tables with unsorted columns in databases. A simple Nested Loops Join and the Classical Hash Join algorithms over two relations R and S are typically not suitable for large tables because the join relation cannot fit into memory. Hence, a partitioned hash join algorithm is commonly used whereby the join execution is partitioned into separate parts. With the present invention of sorting indexes, it can be easy to separate R and S and then perform a hash join for each part locally. In addition, embodiments of the present invention can be applied to hardware-based accelerators. For example, modern FPGAs can sort 128 data in several clock cycles, but this takes a very long time to merge large data, which largely degrades the benefits of high-performance hardware.

Another benefit or application pertaining to embodiments of the present invention is that there is no need to sort the whole database based on one column. One only needs to know the range to accelerate the processing speed. For example, in TPC-H Q9, one needs to hash-join two tables “PARTSUPP” and “LINEITEM”, but they are typically sorted by PARTKEY and ORDERKEY respectively. When the database software cannot handle or store one table in the cache/memory, there needs to be a hash-join piece-by-piece. The complexity is O(mn), in which m is the number of pieces in PARTSUPP and n is the number of pieces in LINEITEM. If there is the sort cache information for PARTKEY in LINEITEM, then the sort can be the LINEITEM based on PARTKEY. And by utilizing the hash join with table PARTSUPP according to embodiments of the present invention, the complexity becomes O(m+n).

In summary, sorting is very important in database operations because many operations require sorted column. Embodiments of the present invention provide an easier and more efficient process to compress data and improve cache hit rates and enhance faster join operations. For example, the C-Store Database is a Column-Oriented DBMS, and can focus on sorting. The sorted data can be ordered on any criteria. However, this typically requires multiple copies. This sorting is a major task in some Database applications. The present invention of a sort cache tree (SCT) can accelerate these applications.

Another benefit of the present invention pertains to data merging. Several sort cache trees (SCTs) can be easily merged together. For example, two nodes with each node having a 4-partition SCT can be merged within one node. The SCT can be also used in a single node. For a single node, the SCT approach is faster than existing approaches because of less disk I/O operations. For example, given that a node has 1G memory and 8G unsorted data on disk, the typical prior art sort-merge approach versus the present invention are compared below:

Sort-merge:

1. Sort: (read disk 1G+sort 1G+write disk 1G)*8

2. Merge into 2G: (read disk 2G+merge 2G+write disk 2G)*4

3. Merge into 4G: (read disk 4G+merge 4G+write disk 4G)*2

4. Merge into 8G: read disk 8G+merge 8G+write disk 8G

Total: read disk 32G+sort 8G+merge 24G+write disk 32G

In the Present Invention:

1. Partition: read disk 8G+write disk 8G

2. Sort: (read disk 1G+sort 1G+write disk 1 G)*8

Total: read disk 16G+sort 8G+write disk 16G

In comparison, the prior art requires 96G versus only 40G for embodiments of the present invention. There is over 50% improvement in efficiency.

In some embodiments, the data structure of the sorting index could be a binary tree or special hardware similar as the ternary content addressable memory (TCAM), whereby the input key is compared with many ranges in parallel.

Embodiments of the present invention are thus described. While the present invention has been described in particular embodiments, it should be appreciated that the present invention should not be construed as limited by such embodiments, but rather construed according to the following claims.

What is claimed is:

1. A method for sorting a data set stored in a database on a computer system, comprising:
receiving a data processing request for sorting the data set stored in the database;
defining a plurality of partitions for storing values corresponding to the data set;
determining a range of values for the plurality of partitions;
assigning the values of the data set to the partitions according to the range of values corresponding to the plurality of partitions;
sorting the values in the partitions; and
writing sorted partition values to designated memory locations, wherein the entire data set is sorted.

2. The method of claim 1, further comprising:
generating an index comprising information used to assign the values to the plurality of partitions for subsequent sort operations.

3. The method of claim 2, wherein the index comprises a tree data structure.

4. The method of claim 2, wherein the information corresponding to the index includes a current value, a number of a value to be sorted, a number of smaller values, and a number of larger values.

5. The method of claim 4, wherein the information of the index further includes pointers.

6. The method of claim 1, further comprising:
modifying the index when changing, adding or deleting portions of the data set.

7. The method of claim 1, further comprising:
sorting the data set in a subsequent sort operation by using the index.

8. The method of claim 1, further comprising:
generating an index at a run time from initial sort results;
storing the index for use in subsequent sort operations.

9. The method of claim 1, further comprising:
sorting the partitions in parallel by two or more nodes.

10. A computer system for processing a database comprising:
a memory for storing the database having a data set;
a processor coupled to the memory, wherein in response to a sort operation request, generates instructions to partition the data set into a plurality of partitions according to a plurality of contiguous ranges, the values of the data set are assigned to partitions according to the ranges and the values for each partition are to be sorted by multiple nodes in parallel and wherein results of sort operations for the partitions are written to contiguous memory locations resulting in a sorted data set.

11. The computer system of claim 10, wherein the processor generates an index comprising information used to assign the values to the plurality of partitions for subsequent sort operations.

12. The computer system of claim 11, wherein the index comprises a tree data structure.

13. The computer system of claim 12, wherein the information corresponding to the index includes a current value, a number of a value to be sorted, a number of smaller values, and a number of larger values.

14. The computer system of claim 13, wherein the information corresponding to the index further includes pointers.

15. The computer system of claim 10, wherein the processor updates the index when changing, adding or deleting portions of the data set.

16. The computer system of claim 15, wherein the nodes sort the data set in a subsequent sort operation by using the index.

17. The computer system of claim 10, wherein the processor generates an index at a run time from initial sort results and the memory stores the index for use in subsequent sort operations.

18. A method for sorting a data set stored in a database comprising:
selecting a value used to determine a plurality of ranges, wherein the ranges span the data set;
assigning each piece of data corresponding to the data set to one of the plurality of ranges;
sorting the pieces of data in one range simultaneously while sorting the pieces of data in another range;
arranging the ranges, once sorted, contiguously to result in a sorted data set.

19. The method of claim 18 further comprising storing information pertaining to the ranges in memory for retrieval and use in subsequent sort operations.

20. The method of claim 19, wherein the information is stored in a tree data structure.

21. The method of claim 19, wherein the information is stored in an array.

22. The method of claim 19, wherein the information is stored in a heap structure.
